(19) United States
(12) Patent Application Publication
(10) Pub. No.: US 2023/0117161 A1
(43) Pub. Date: Apr. 20, 2023

(54) METHOD AND SYSTEM FOR CONTROLLING A FLOATING WINDOW

(71) Applicant: BEIJING DIDI INFINITY TECHNOLOGY AND DEVELOPMENT CO., LTD., Beijing (CN)

(72) Inventor: Shaoying HAN, Beijing (CN)

(73) Assignee: BEIJING DIDI INFINITY TECHNOLOGY AND DEVELOPMENT CO., LTD., Beijing (CN)

(21) Appl. No.: 18/067,678

(22) Filed: Dec. 16, 2022

Related U.S. Application Data
(63) Continuation of application No. PCT/CN2021/112898, filed on Aug. 17, 2021.

(30) Foreign Application Priority Data
Sep. 16, 2020 (CN) 202010983846.7

(51) Int. Cl. G06F 3/04886; G06F 3/04815

(52) U.S. Cl. CPC G06F 3/04886; G06F 3/04815

(57) ABSTRACT

A method may include acquiring a first operation on a terminal device. The first operation may be used to instruct the terminal device to execute a first application. The method may also include adding a first floating window on a display interface of the terminal device when the first application is executed. The first floating window may include a first state and a second state. The first floating window may be hidden on the display interface in the first state, and displayed on the display interface in the second state. The method may further include adding a second floating window associated with the first application after adding the first floating window. When a relative positional relationship of the first floating window and the second floating window satisfies a first preset condition, the first state of the first floating window may be switched to the second state.

### CROSS-REFERENCE TO RELATED APPLICATIONS

This application is a continuation of PCT/CN2021/112898, field on Aug. 17, 2021, which claims priority to Chinese Application No. 202010983846.7 filed on Sep. 16, 2020, the entire contents of each of which are incorporated herein by reference.

### TECHNICAL FIELD

The present disclosure relates to computer technology, and in particular, to a method and a system for controlling a floating window.

### BACKGROUND

With the development of science and technology, many types of applications appear on terminal devices, such as chat software, taxi software, navigation software, photography software, etc. These applications enrich people's daily life. In practical applications, users may often switch between multiple applications. For example, when a user uses chat software to chat, he may switch to shooting software to take pictures with a mobile phone. At this time, the chat software can run in the background of the terminal device. After the user switches from a first application to a second application, if he wants to return to the first application, the system task bar of the terminal device may be used, or the terminal device may first enter the system desktop, and then switch back to the first application, which may be more complicated. If a floating window of the first application is added to the display interface of the terminal device when the first application is executed in the background, the user may obtain the information of the first application through the floating window and the terminal device may quickly access the first application.

Therefore, it is desirable to provide methods and systems for controlling a floating window.

### SUMMARY

One aspect of the present disclosure provides a method for controlling a floating window. The method may include acquiring a first operation performed by a user on a terminal device. The first operation may be used to instruct the terminal device to execute a first application in a background. The method may also include adding a first floating window automatically on a display interface of the terminal device when the first application is executed in the background. The first floating window may include a first state and a second state. The first floating window may be hidden on the display interface in the first state and displayed on the display interface in the second state. The method may also include adding a second floating window associated with the first application after adding the first floating window, the second floating window covering a partial area of the display interface. When a relative positional relationship of the first floating window and the second floating window satisfies a first preset condition, the first state of the first floating window may be switched to the second state; and wherein the first floating window is configured to close the second floating window.

Another aspect of the present disclosure provides a system for controlling a floating window. The system may include an acquisition module configured to acquire a first operation performed by a user on a terminal device. The first operation may be used to instruct the terminal device to execute a first application in a background. The system may also include a first adding module configured to automatically add a first floating window automatically on a display interface of the terminal device when the first application is executed in the background. The first floating window may include a first state and a second state. The first floating window may be hidden on the display interface in the first state. The first floating window may be displayed on the display interface in the second state. The system may further include a second adding module configured to add a second floating window associated with the first application after adding the first floating window, the second floating window covering a partial area of the display interface. When a relative positional relationship of the first floating window and the second floating window satisfies a first preset condition, the first state of the first floating window may be switched to the second state. The first floating window may be configured to close the second floating window.

Another aspect of the present disclosure provides a floating window control device including at least one processor. The at least one processor may be configured to execute the method for controlling a floating window according to any embodiment of the present disclosure.

Another aspect of the present disclosure provides an electronic device. The electronic device may include a storage device and at least one processor coupled to the storage device. The processor may be configured to perform the method for controlling a floating window described in any embodiment of the present disclosure.

Another aspect of the present disclosure further provides a computer-readable storage medium. The storage medium may store computer instructions. After a computer reads the computer instructions in the storage medium, the computer may be configured to execute the method for controlling a floating window described in any embodiment of the present disclosure.

### BRIEF DESCRIPTION OF THE DRAWINGS

The present disclosure will be further described in the form of exemplary embodiments, which will be described in detail by the accompanying drawings. These embodiments are not restrictive. In these embodiments, the same number represents the same structure, wherein:

FIG. 1 is a diagram of an application scenario of a system for controlling a floating window according to some embodiments of the present disclosure.

FIG. 2 is an exemplary block diagram of a system for controlling a floating window according to some embodiments of the present disclosure.

FIG. 3 is an exemplary flowchart of a process for controlling a floating window according to some embodiments of the present disclosure.

FIGS. 4-6 are schematic diagrams of a process for controlling a floating window according to some embodiments of the present disclosure.

### DETAILED DESCRIPTION

In order to more clearly explain the technical scheme of the embodiments of the present disclosure, the following will briefly introduce the drawings that need to be used in the description of the embodiments. Obviously, the drawings in the following description are only some examples or embodiments of the present disclosure. For those skilled in the art, the present disclosure can also be applied to other similar scenarios according to these drawings without creative work. Unless it is obvious from the language environment or otherwise stated, the same label in the figure represents the same structure or operation.

It should be understood that the “system”, “device”, “unit” and/or “module” used herein is a method for distinguishing different components, elements, parts or assemblies at different levels. However, if other words can achieve the same purpose, they can be replaced by other expressions.

As shown in the description and the claims, unless the context expressly indicates exceptions, the words “a”, “an”, “the”, “one”, and/or “this” do not specifically refer to the singular, but may also include the plural; and the plural forms may be intended to include the singular forms as well, unless the context clearly indicates otherwise. Generally speaking, the terms “include” only indicate that the steps and elements that have been clearly identified are included, and these steps and elements do not constitute an exclusive list. Methods or equipment may also include other steps or elements.

A flowchart is used in this disclosure to explain the operation performed by the system according to the embodiment of the present disclosure. It should be understood that the previous or subsequent operations are not necessarily performed accurately in order. Instead, the steps may be processed in reverse order or simultaneously. At the same time, you can add other operations to these processes, or remove one or more steps from these processes.

In the present disclosure, “user”, “passenger”, “requester”, “service requester” and “customer” may be used interchangeably to refer to an individual requesting or ordering a service. Also, “provider,” “service provider,” and “supplier” may be used interchangeably to refer to a person, entity, or instrument that provides a service or facilitates the provision of a service. The term “party” may refer to an individual requesting or ordering a service, an entity or individual that can provide the service. The term “terminal device” in the present disclosure may refer to a tool for requesting a service, ordering a service, facilitating a service request, providing a service, or facilitating the provision of a service.

In some embodiments, a floating window associated with a first application may be added to the terminal device, so that the user may obtain information of the first application through the floating window and quick access to the first application when using a second application or staying on a system interface of the terminal device. In practical applications, the user may wish to close the floating windows of the application for various reasons. For example, the first application may need to be exited or closed due to a limitation of a system storage space. Some embodiments of the present disclosure provide a method for controlling a floating window, which may be used for a terminal device with an Android operating system. The Android operating system may determine a display level of the floating window on the display interface of the terminal device based on an adding order of the floating window. In some embodiments, a deleted floating window (i.e., the first floating window) for closing a main floating window (i.e., the second floating window) may be added first, and then the main floating window may be added, so that the second floating window in the display interface may be displayed. The display level of the second floating window may be higher than the display level of the first floating window, so that the second floating window may be closed through the first floating window.

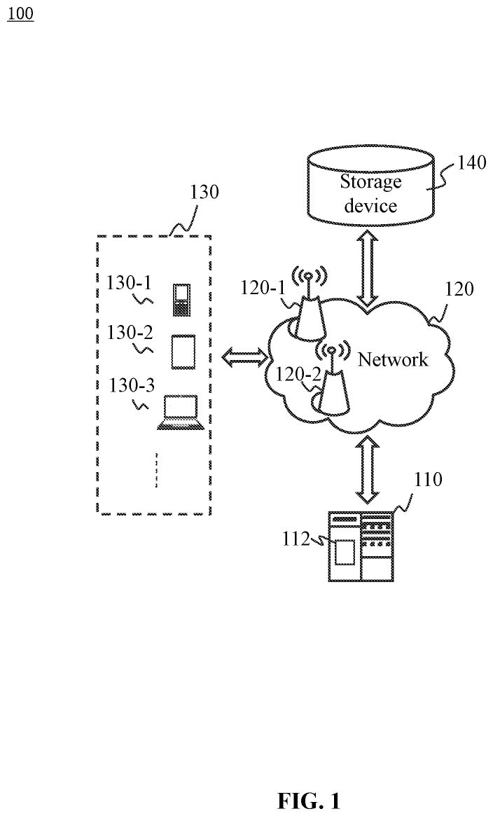

FIG. 1 is a diagram of an application scenario of a system for controlling a floating window according to some embodiments of the present disclosure.

As shown in FIG. 1, in some embodiments, the system 100 for controlling a floating window (also referred to as floating window control system) may control the floating window (e.g., the second floating window) based on an operation (e.g., dragging, clicking, selecting, etc.) of the user. The system 100 for controlling a floating window may be an online service platform for Internet services. For example, the system 100 for controlling a floating window may be an online transportation service platform for transportation services. In some embodiments, the system 100 for controlling a floating window may be applied to a car-hailing service, such as a taxi call service, an express call service, a private car call service, a minibus call service, a carpooling service, a bus service, a driver hiring and pickup service, or the like. In some embodiments, the system 100 for controlling a floating window may be applied to a chauffeur service, an express delivery service, a takeaway service, a social networking service, a message service, or the like. In some alternative embodiments, the system 100 for controlling a floating window may be applied to a game service, a travel (e.g., tourism) service, an education (e.g., online education) service, a news service, a music service, and other fields. The system 100 for controlling a floating window may be an online service platform including a server 110, a network 120, a terminal device 130, and a storage device 140. The server 110 may include a processing device 112.

In some embodiments, the server 110 may be configured to process information and/or data related to floating window control. The server 110 may be an independent server or a group of servers. The server group may be centralized or distributed (e.g., the server 110 may be a distributed system). In some embodiments, the server 110 may be local or remote. For example, the server 110 may access the information and/or data stored in the terminal device 130 and the storage device 140 through the network 120. In some embodiments, the server 110 may directly connect with the terminal device 130 and the storage device 140 to access information and/or data stored therein. In some embodiments, the server 110 may execute on a cloud platform. For example, the cloud platform may include one or any combination of a private cloud, a public cloud, a hybrid cloud, a community cloud, a decentralized cloud, an internal cloud, or the like.

In some embodiments, the server 110 may include the processing device 112. The processing device 112 may process data and/or information related to floating window control to perform one or more of the functions described herein. For example, the processing device 112 may receive a signal sent by the user to cancel the display of the floating window, and no longer add the floating window when the user opens an application next time. In some embodiments, the processing device 112 may include one or more sub-processing devices (e.g., a single-core processing device or a multi-core multi-core processing device). By way of example only, the processing device 112 may include a central processing unit (CPU), an application specific integrated circuit (ASIC), an application specific instruction processor (ASIP), a graphics processing unit (GPU), a physical processor (PPU), a digital signal processor (DSP), a field programmable gate array (FPGA), a programmable logic circuit (PLD), a controller, a microcontroller unit, a reduced instruction set computer (RISC), a microprocessor, etc. or any combination thereof.

The network 120 may facilitate exchange of data and/or information. In some embodiments, one or more components in the system 100 for controlling a floating window (e.g., the server 110, the terminal device 130, the storage device 140) may send data and/or information to other components of the system 100 for controlling a floating window via the network 120. In some embodiments, the network 120 may be any type of wired or wireless network. For example, the network 120 may include a cable network, a wireline network, a fiber optic network, a telecommunications network, an intranet, an Internet, a local area network (LAN), a wide area network (WAN), a wireless area network (WLAN), a metropolitan area network (MAN), a Public Switched Telephone Network (PSTN), a Bluetooth network, a ZigBee network, a Near Field Communication (NFC) network, etc. or any combination thereof. In some embodiments, the network 120 may include one or more network entry and exit points. For example, the network 120 may include wired or wireless network entry and exit points, such as base stations and/or Internet exchange points 120-1, 120-2, . . . , through the wired or wireless network entry and exit points, one or more components of the system 100 for controlling a floating window may be connected onto the network 120 to exchange data and/or information. At least one terminal device 130 may communicate and/or connect with the processing device 112 and/or the storage device 140. For example, data including the shape and size of the second floating window set by the user acquired by the processing device 112 may be stored in the storage device 140.

In some embodiments, the terminal device 130 may include a display interface. The display interface may refer to a page displayed on the display screen of the terminal device. The display interface may be configured to display images, text, or buttons/options that can be manipulated by the user. The user may realize the corresponding function by operating a content in the display interface. For example, when the terminal device is a mobile phone with a touch screen, the user may control the floating window, such as moving, closing etc., by dragging or clicking on the floating window of the display interface. In some embodiments, the user may control the floating window of the display interface by performing corresponding operations on the terminal device 130. In some embodiments, the terminal device 130 may include a mobile device 130-1, a tablet computer 130-2, a laptop computer 130-3, a vehicle built-in device, or the like, or a combination thereof. In some embodiments, the mobile device 130-1 may include a smart home device, a wearable device, a smart mobile device, a virtual reality device, an augmented reality device, etc., or any combination thereof. In some embodiments, the smart home device may include a smart lighting device, a control device for a smart appliance, a smart monitoring device, a smart TV, a smart camera, a walkie-talkie, etc., or any combination thereof. In some embodiments, the wearable device may include a smart bracelet, smart footwear, smart glasses, a smart helmet, a smart watch, a smart clothing, a smart backpack, smart accessories, etc., or any combination thereof. In some embodiments, the smart mobile device may include a smart phone, a personal digital assistant (PDA), a gaming device, a navigation device, a POS device, etc., or any combination thereof. In some embodiments, the virtual reality device and/or the augmented reality device may include a virtual reality headset, virtual reality glasses, virtual reality goggles, an augmented reality helmet, augmented reality glasses, augmented reality goggles, etc., or any combination thereof. In some embodiments, the terminal device 130 may include a device with a positioning function to determine the position of the user and/or the terminal device 130.

The storage device 140 may be configured to store data and/or instructions. In some embodiments, the storage device 140 may store data obtained from the terminal device 130. In some embodiments, the storage device 140 may store information and/or instructions for execution or use by the server 110 to perform one or more processes described herein. In some embodiments, the storage device 140 may include mass storage, removable storage, volatile read-write memory (e.g., random access memory RAM), read-only memory (ROM), or the like, or any combination thereof.

It should be noted that the above description is provided for illustrative purposes only and is not intended to limit the scope of the present disclosure. Numerous changes and modifications may be made to those of ordinary skill in the art under the guidance of the contents of the present disclosure. The features, structures, methods, and other features of the exemplary embodiments described herein may be combined in various ways to obtain additional and/or alternative exemplary embodiments. For example, the storage device 140 may be a data storage device 140 including a cloud computing platform, such as a public cloud, a private cloud, a community and hybrid cloud, or the like. However, such changes and modifications do not depart from the scope of the present disclosure.

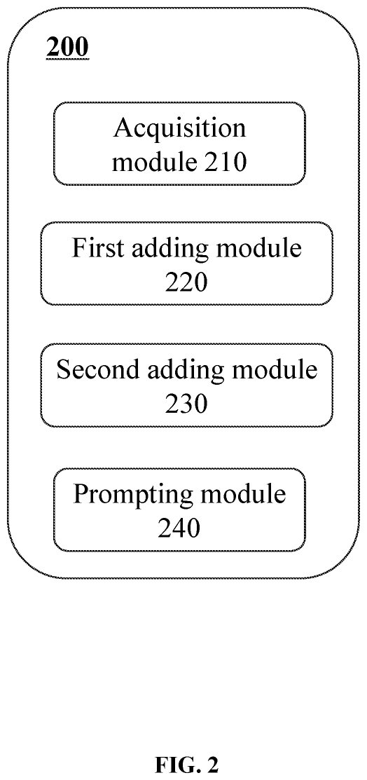

FIG. 2 is an exemplary block diagram of a system for controlling a floating window according to some embodiments of the present disclosure. As shown in FIG. 2, the system 200 for controlling a floating window may include an acquisition module 210, a first adding module 220, a second adding module 230 and a prompting module 240. In some embodiments, the system 200 for controlling a floating window may be implemented by the system 100 for controlling a floating window (e.g., the processing device 112) shown in FIG. 1.

In some embodiments, the acquisition module 210 may be configured to obtain a first operation performed by the user on the terminal device, where the first operation may be used to instruct the terminal device to execute the first application in the background. For more details about acquiring the first operation of the user on the terminal device, please refer to the detailed description of operation 310, which will not be repeated here.

In some embodiments, the first adding module 220 may be configured to automatically add the first floating window on the display interface of the terminal device when the first application is executed in the background. The first floating window may include a first state and a second state; when the first floating window is in the first state, the first floating window may be hidden on the display interface; when the first floating window is in the second state, the first floating window may be displayed on the display interface. For more details about the first floating window and the first state and the second state of the first floating window, please refer to the detailed description of operation 320, which will not be repeated here.

In some embodiments, the second adding module 230 may be configured to add the second floating window associated with the first application after adding the first floating window, and the second floating window may cover a partial area of the display interface. When a relative positional relationship between the second floating window and the first floating window satisfies a first preset condition, the first state of the first floating window may be switched to the second state. The first floating window may be configured to close the second floating window. For more details about adding the second floating window and the first floating window, please refer to the detailed description of operation 320, which will not be repeated here.

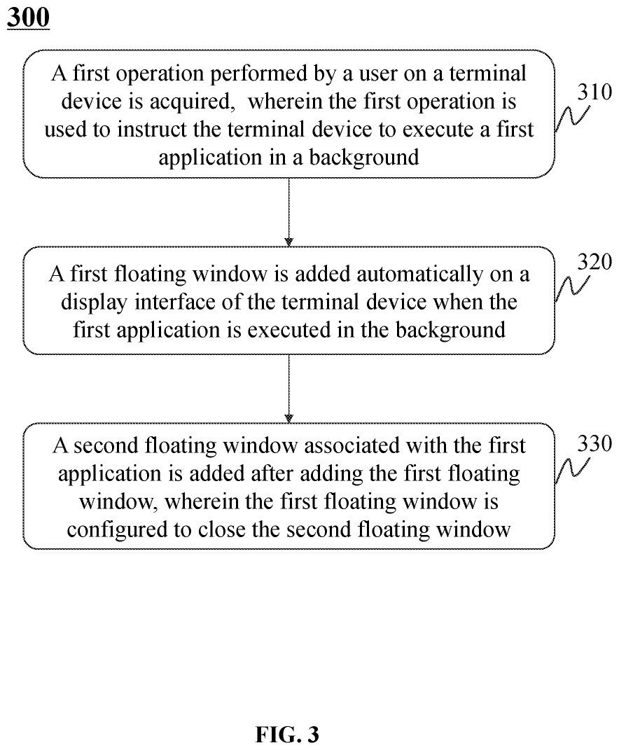

The prompting module 240 may be configured to switch the second state of the first floating window to a third state when the relative positional relationship of the first floating window and the second floating window satisfies the first preset condition. In some embodiments, the prompting module 240 may switch the second state of the first floating window to the third state (e.g., changing a color of the first floating window to prompt the user to stop operating the second floating window and, that the second floating window may be closed), if the second floating window overlaps the first floating window when the first state of first floating window is switched to the second state. For more details about the third state of the first floating window, please refer to the detailed description of FIG. 3, which will not be repeated here.

It should be noted that the above description of the system 200 for controlling a floating window and its devices/modules is only for convenience of description, and does not limit the present disclosure to the scope of the illustrated embodiments. It can be understood that for those skilled in the art, after understanding the principle of the system, it is possible to arbitrarily combine various devices/modules without departing from this principle, or form a subsystem to connect with other devices/modules. For example, the first adding module 220 and the second adding module 230 disclosed in FIG. 2 may be different modules in one device (e.g., the processing device 112), or may be one module that implements the functions of the above two or more modules. For another example, each module may have its own storage module. For another example, each module may share one storage module. Such deformations are all within the protection scope of the present disclosure.

FIG. 3 is an exemplary flowchart of a process for controlling a floating window according to some embodiments of the present disclosure. In some embodiments, the process 300 for controlling a floating window may be performed by the system 100 for controlling a floating window (e.g., the processing device 112), or the system 200 for controlling a floating window. For example, the process 300 for controlling a floating window may be stored in a storage device (e.g., the storage device 140) in a form of a program or an instruction, and when the system 100 for controlling a floating window (e.g., the processing device 112) executes the program or instruction, the process 300 for controlling a floating window may be implemented. In some embodiments, the process 300 for controlling a floating window may be implemented by the server 110 (e.g., the processing device 112).

In 310, a first operation performed by a user on a terminal device may be acquired. The first operation may be used to instruct the terminal device to execute a first application in a background. In some embodiments, operation 310 may be performed by the acquisition module 210.

In some embodiments, the terminal device may have an Android operating system. The terminal device may include a mobile phone, a tablet computer, a notebook computer, a smart watch, etc., that have an Android operating system. The Android operating system may determine display levels of floating windows on the display interface of the terminal device based on an adding sequence of the floating windows. For example, if the first floating window is added first and then the second floating window is added to the terminal device with the Android operating system, in the display interface of the terminal device, the display level of the first floating window may be below the display level of the second floating window. In some embodiments, the operating system of the terminal device may be any one of an iOS operating system, a Blueberry operating system, a Microsoft operating system, etc.

The user may refer to the user of the terminal device. In some embodiments, the user may perform different types of operations on the terminal device, so that the terminal device may perform functions corresponding to the operations. For example, the user may click a certain position on the display interface of the terminal device, so that the terminal device may run an application corresponding to the position, or execute a function corresponding to the position.

The first operation may refer to any operation performed by the user that can instruct the terminal device to execute the first application in the background. In some embodiments, the first operation may include a gesture operation, a voice operation, a keypress operation, or the like. The gesture operation may refer to an operation performed by the user on the screen of the terminal device using a hand (e.g., a finger) or other body parts, including sliding the screen left and right, sliding the screen up and down, double-clicking the screen, and continuously pressing and holding the screen. The voice operation may refer to a voice message issued by the user, for example, “switching to the second application.” The keypress operation may refer to the user controlling the terminal device by pressing a keypress or option button on the terminal device. For example, pressing a home button of the terminal device may return to a system interface of the terminal device, and pressing the home button and a volume button simultaneously may take a screenshot of the current content of the display interface of the terminal device. In some embodiments, the first operation may include, instructing the terminal device to exit a current application, entering the second application, minimizing the current application, etc., indicating that the user is no longer using the first application.

In some embodiments, the second application may include a social software, an education software, a news software, a camera software, a takeaway software, a navigation software, a music software, or the like. The first application and the second application may be of the same type, for example, the first application may be a chat software, and the switched second application may also be a chat software. The first application and the second application may be of different types. For example, the first application may be a taxi-hailing software (e.g., a car-hailing APP), and the switched second application may be a navigation software (e.g., a map APP). In some embodiments, when the first application is executed in the background, the current display interface of the terminal device may be an interface other than the first application such as the system interface or the interface of the second application which is not limited in the present disclosure.

In 320, a first floating window may be added automatically on a display interface of the terminal device when the first application is executed in the background. In some embodiments, operation 320 may be performed by the first addition module 220.

In some embodiments, the first floating window may reflect an area or position where a main floating window (e.g., the second floating window) of the first application is closed. In some embodiments, the first floating window may include a first state and a second state. When the first floating window is in the first state, the first floating window may be hidden on the display interface of the terminal device; when the first floating window is in the second state, the first floating window may be displayed on the display interface of the terminal device.

In some embodiments, when the first floating window is in the first state, the first floating window may be hidden from the display interface of the terminal device by setting length and width pixels of the first floating window to be smaller than a preset value. For example, the length pixel and width pixel of the first floating window may be set to 1. When the length pixels and width pixels of the first floating window are 1, the user may not observe the first floating window with naked eyes, so the first floating window may be hidden on the display interface. As another example, the length and width pixels of the first floating window may be set to 0.5, or 0.3, or 1.5, or 2, etc. In some alternative embodiments, a preset value of length and width pixels of the floating window may be any value that can prevent the floating window from being observed by human eyes, which is not limited in the present disclosure. In some embodiments, the first floating window may be hidden from the display interface of the terminal device by setting the first floating window in a transparent form. For example, a color of the first floating window in the first state may be set to a transparent color, or a color similar to the display interface of the terminal device may be set, or the like. In some embodiments, the first floating window may be hidden from the display interface by setting the size of the first floating window. For example, when the first floating window is in the first state, the size of the first floating window may be set to a size of a point, so that the first floating window may be hidden from the display interface of the terminal device. In some alternative embodiments, the first state of the first floating window may be set in any reasonable manner, so that the first floating window may be hidden from the display interface of the terminal device.

In some embodiments, the first floating window may be in a first state when initially added, and when a preset condition is met, the first floating window may be switched from the first state to the second state, and when a state corresponding to the preset condition disappears, the first floating window may be switched back to the first state from the second state, or the first floating window may be closed, or switched to other states. For example, when the main floating window (e.g., the second floating window) of the first application is dragged to a preset area, the first floating window may be switched from the first state to the second state to prompt the user to close an area or position of the main floating window of the first application; when the second floating window leaves the preset area, the first floating window may be switched back from the second state to the first state. In some embodiments, when the first floating window is in the second state, the color of the first floating window may be a color such as light gray that can display a content of the display interface where the first floating window is located.

In some embodiments, a shape of the first floating window may be a fan shape. In some embodiments, the fan shape may be located at a lower right corner of the display interface of the terminal device. It can be understood that setting the shape of the first floating window into a fan shape may better fit a corner of the display interface, which is not a limitation of the present disclosure. In some alternative embodiments, the shape of the first floating window may be any shape such as a circle, a square, a polygon, etc., and the first floating window may be set at any position of the display interface, for example, the corner of the display interface, the size of the first floating window may be any reasonable value on a side, or other positions (e.g., a central area) of the display interface, etc., which is not limited in the present disclosure. In some embodiments, the size, and/or shape, and/or position of the first floating window may be set by default by the system, or may be set according to user settings.

In some embodiments, the first floating window may be added when the user opens the first application. In some embodiments, whether to add the first floating window may be determined according to a request result by sending a request for enabling a permission of the floating window to the user. For example, the option of whether to authorize a display of the floating window may be sent to the user, and displayed on the display interface; when the user agrees to the permission to add the floating window, the floating window may be automatically added when the first application runs in the background. In some embodiments, a permission request may be sent to the user when the user exits the first application interface to the system interface or switches to the second application.

In some alternative embodiments, a floating window display request may also be issued to the user. For example, options to display a floating window (e.g., the second floating window) and not to display a floating window. Similarly, the floating window display request may be sent to the user when the user opens the first application, or may be sent to the user when the user exits the first application to the system interface or switches to the second application. If the user chooses to display the floating window, the floating window of the first application (e.g., the first floating window, the second floating window) may be displayed when the user switches to the system interface or uses the second application. If the user chooses not to display the floating window, the floating window may not be displayed, even if the user has given permission to add a floating window.

In some embodiments, a request for permission to display a floating window and/or a request for displaying a floating window may be sent every time a user opens an application, or a request for permission to display a floating window and/or a request for displaying a floating window may only be sent when the user opens the application for the first time. In some embodiments, the user may change the floating window permission solicitation option and/or the floating window display option by adjusting settings of the terminal device.

In 330, a second floating window associated with the first application may be added after adding the first floating window, wherein the first floating window may be configured to close the second floating window. In some embodiments, operation 330 may be performed by the second addition module 230.

In some embodiments, the second floating window may be the main floating window of the first application, which may be configured to display information related to the first application. For example, a main floating window of a social software may display messages sent by friends or the system, and a main floating window of a music or video software may display a title of a currently playing song, drama, etc. In some embodiments, the second floating window may be configured to quickly switch back to the first application. For example, the user may directly enter the first application by clicking (such as single-clicking, double-clicking, etc.) on the second floating window. In some embodiments, different operation options may be set for the second floating window, so as to match different operations with an effect achieved. For example, setting a double-click on the second floating window may control the display interface to switch back from the second application to the first application. As another example, setting a long press on the second floating window may call up a content list displayed by the second floating window, and select a content that you want to display on the second floating window, and so on.

In some embodiments, the second floating window may include, but be not limited to, an icon of the first application, a name of the first application, an abbreviated content of the first application, and other information. The abbreviated content of the first application may be understood as relatively important information in the first application. For example, when the first application is an online car-hailing APP, the abbreviated content may refer to a remaining time and remaining distance to a destination.

In some embodiments, the second floating window may cover a partial area of the display interface. In some embodiments, the position of the second floating window may be set by the user as required. For example, the user may drag the second floating window to different positions on the display interface. In some embodiments, the shape of the second floating window may include, but be not limited to, a circle, a square, a polygon, and the like. In some embodiments, the size of the second floating window may be fixed, or may vary within a range. In some embodiments, when the first floating window is switched to the second state, the size of the first floating window may be larger than the size of the second floating window.

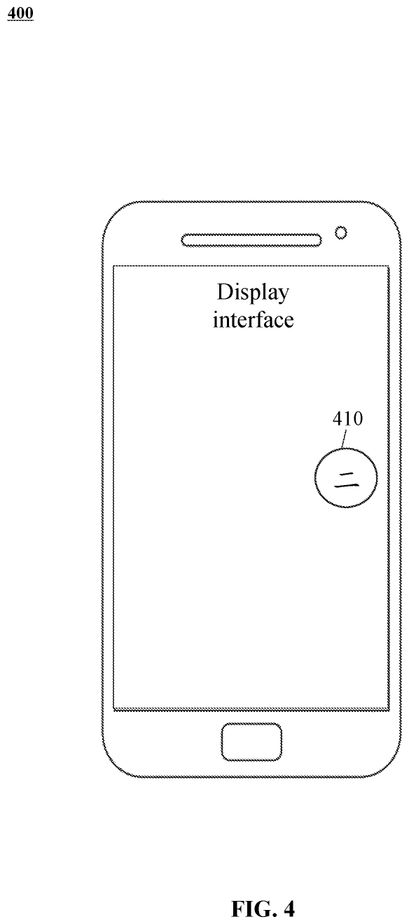

In some embodiments, the second floating window may be dragged to any position on the display interface, and when the operation stops (e.g., the finger stops dragging and leaves the screen), the second floating window may be fixed at that position. In this way, the purpose of adjusting the position of the second floating window may be achieved. In some embodiments, the position of the second floating window adjusted by the user may be optimized so that the second floating window may not hinder the user from using the second application. For example, when the user drags the second floating window to a central area of the display interface, the processing device may adsorb the second floating window to a right, left, upper, and lower sides of the central area, thereby vacating the display interface. A central position so users know what's in that location. As another example, when the user drags the second floating window to a position close to the side or corner of the display interface, the processing device may adsorb the second floating window to the side or corner (the lower right corner as shown in FIG. 4). In some embodiments, areas in the display interface where the second floating window cannot be placed may be set. When the user drags the second floating window to these areas, colors of these areas may change to prompt the user “this area cannot be placed.” For example, it may be set that no second floating window can be placed in the central area of the display interface, and no second floating window can be placed on the side of the display interface, etc.

In some embodiments, the second floating window may also be added when the first application is opened. In order to realize a purpose of closing the second floating window after dragging the second floating window to the first floating window, an order of adding the second floating window may be located after the first floating window.

In the Android operating system, a display level of the floating window added in a later order may be higher than a display level of the floating window added in a previous order. Specially, when two floating windows overlap at least partially, a floating window (for example, the second floating window) added in a later order may be located on an upper layer of the floating window (for example, the first suspension window) added in the front order. (For example, the second floating window) is located on the upper layer of the floating window (for example, the first floating window) added in a previous order. By adding the first floating window first and then adding the second floating window, the first floating window may be located at a lower layer of the second floating window, so that the first floating window may be configured to close the second floating window.

In some embodiments, when a relative positional relationship between the second floating window and the first floating window satisfies a first preset condition, the first floating window may be switched from the first state to the second state. For example, when the second floating window is dragged to a periphery or the preset area of the first floating window, the first floating window may be displayed on the display interface of the terminal device. In some embodiments, when the relative positional relationship between the second floating window and the first floating window satisfies the first preset condition, the color of the first floating window area may change, for example, become gray, light red, light blue etc., it may not only remind the user that the current second floating window is in a draggable state, but also does not prevent the user from continuing to operate the second application or other modules in the display interface of the terminal device.

In some embodiments, when the first floating window is switched from the first state to the second state, if the second floating window overlaps the first floating window, the first floating window may be switched from the second state to the third state, to prompt the user to stop operating the second floating window at this time, and the second floating window may be closed. When the first floating window is switched to the third state, the first floating window may undergo a series of changes to prompt the user. For example, when the user drags the second floating window into the first floating window area, the color of the first floating window may be changed from light gray to red to prompt the user to stop operating the second floating window at this time, and the second floating window may be closed. If the user continues to perform an operation on the second floating window, the second floating window may not be closed, and when the second floating window leaves the first floating window and reaches a certain area (e.g., an area of the first preset condition), the color of the first floating window may be switched to an original color (such as light gray, transparent, etc.).

In some embodiments, when the second floating window partially overlaps the first floating window, the first floating window may be switched from the second state to the third state, so as to prompt the user to stop an operation on the second floating window at this time. The second floating window may be closed.

It should be noted that the above description about the method 300 is only for example and illustration, and does not limit the scope of the present disclosure. Various modifications and changes may be made to the method 300 to those skilled in the art under the guidance of the present disclosure. However, these corrections and changes are still within the scope of the present disclosure. For example, in operation 330, an obtained result of the user for a pop-up option may be stored in the storage device 140. As another example, the size and shape of the floating window (e.g., the first floating window and the second floating window) may be adjusted according to user settings.

FIG. 4 to FIG. 6 are schematic diagrams of method for controlling a floating window according to some embodiments of the present disclosure.

As shown in FIG. 4 to FIG. 6, the first application is in a background execution state at this time, and the display interface of the terminal device may display the second application or a system interface.

As used herein, in the display interface shown in FIG. 4, the first floating window is in the first state. That is, the first floating window is hidden in the display interface and cannot be observed by the user. The second floating window 410 is located on the right side of the display interface, and the display content of the second floating window 410 may be the icon of the first application. In some embodiments, the display content of the second floating window 410 may be set as a logo of the first application by default. In some embodiments, content selected by the user and desired to be displayed in the second floating window may be obtained.

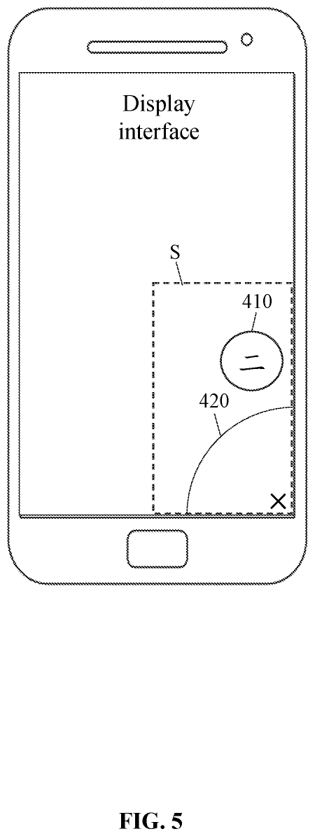

In the display interface shown in FIG. 5, the second floating window 410 is dragged into the preset area S, and the first floating window 420 is switched to the second state at this time because the preset condition is satisfied. In some embodiments, in order to prompt the user that the fan-shaped area (i.e., the first floating window) is configured to close the second floating window, a symbol “x” may be displayed in the first floating window, as shown in FIG. 5. In some embodiments, a position and a size of the preset area S may be default settings, or may be set by the user. In some embodiments, a rectangular display interface may be divided into left, middle, and right parts with equal area and shape, and the position of the preset area S may be the right side of the display interface by default. In some embodiments, the user may also set the preset area S to be the left side of the display interface. The present disclosure does not limit the setting of the preset area S. Similarly, in some embodiments, the size of the preset area S may also be set according to actual needs, and may also be adjusted according to the first floating window 420 in the second state. For example, if a sector radius of the first floating window 420 in the second state is 1.5 cm, the preset area S may be a square with a side length greater than or equal to 1.5 cm.

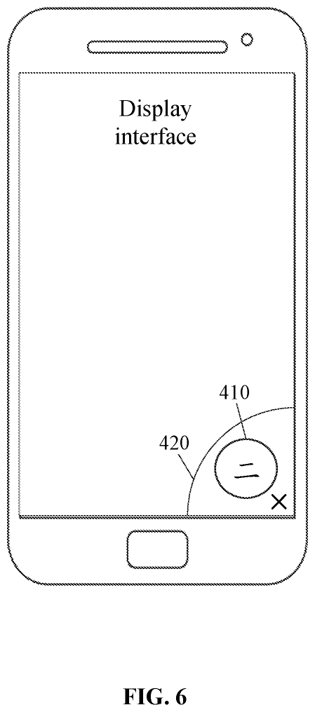

The display interface shown in FIG. 6 shows that the second floating window 410 is dragged to overlap with the first floating window 420 in the second state. At this time, the first floating window may be switched from the second state to the third state, for example, the color of the first floating window 420 may change to a highlighted color such as red, green, yellow, etc., to remind the user that the second floating window 410 can be closed by stopping the operation. The present disclosure does not limit a change of the color of the first floating window, as long as it can play a role of reminding the user. In some embodiments, when the second floating window 410 is dragged to overlap with the first floating window 420 in the second state, that is, when the first floating window is switched to the third state, an option of whether to close the second floating window may pop up. In some embodiments, when the first floating window is in the third state and the user stops operating the second floating window, an option to ask the user whether to confirm closing the second floating window may pop up. If the user selects OK to close the second floating window, the display interface may no longer display the second floating window. If the user chooses to cancel the closing of the second floating window, the second floating window may be adjusted to a position before a drag operation or other suitable positions. In some embodiments, when the second floating window is closed, the first floating window may be closed simultaneously.

In some embodiments, when the second floating window is closed, a floating window closing option may pop up to confirm to the user whether to temporarily close the floating window or permanently close the floating window. If the user selects an option of temporarily closing the floating window, the first floating window and the second floating window may be sequentially added when the first application is executed in the background after the user opens the first application next time. If the user selects an option of permanently closing the floating window, the first floating window and the second floating window may not be added when the user opens the first application or the first application is executed in the background. If the user wants to turn on the floating window function again, it can be achieved by changing the settings in the terminal device.

It can be understood that FIG. 4 to FIG. 6 and their descriptions are only examples and are not intended to limit the present disclosure. In some alternative embodiments, displays, proportions, sizes, shapes, positions, etc. of the first floating window and the second floating window may be any situation other than those shown in FIGS. 4 to 6.

One of the embodiments of the present disclosure provides an electronic device, the electronic device may include a storage device, and at least one processor coupled to the storage device. The processor may be configured to execute the method for controlling a floating window described in any embodiment of the present disclosure. In some embodiments, the electronic device may be a terminal device or any other type of electronic device, which are not limited in the present disclosure.

The possible beneficial effects of the embodiments of the present disclosure may include, but be not limited to: (1) by adding and deleting a floating window (i.e., the first floating window), the user can be reminded to close the position or area of the main floating window (i.e., the second floating window); (2) setting the first floating window to the first state that can make the first floating window be hidden in the display interface and the second state that can make the first floating window be displayed on the display interface may prevent the first floating window from blocking the displayed content in the display interface of the terminal device. It should be noted that different embodiments may have different beneficial effects, and in different embodiments, possible beneficial effects may be any one or a combination of the above, or any other possible beneficial effects.

In other embodiments of the present disclosure, a device for controlling a floating window may be provided, including at least one processor. The at least one processor may be configured to execute the method for controlling a floating window described in other embodiments of the present disclosure.

In other embodiments of the present disclosure, a computer-readable storage medium may be provided, the storage medium may store computer instructions, and when the computer instructions are executed by a processing device, the method for controlling a floating window described in other embodiments of the present disclosure may be implemented.

The basic concepts have been described above. Obviously, for those skilled in the art, the above detailed disclosure is only an example and does not constitute a limitation of the present disclosure. Although it is not explicitly stated here, those skilled in the art may make various modifications, improvements, and amendments to the present disclosure. Such modifications, improvements and amendments are suggested in the present disclosure, so such modifications, improvements and amendments still belong to the spirit and scope of the exemplary embodiments of the present disclosure.

Meanwhile, the present disclosure uses specific words to describe the embodiments of the present disclosure. For example, “one embodiment”, and/or “some embodiments” mean a certain feature or structure related to at least one embodiment of the present disclosure. Therefore, it should be emphasized and noted that “one embodiment” or “an alternative embodiment” mentioned twice or more in different positions in the present disclosure does not necessarily refer to the same embodiment. In addition, certain features or structures in one or more embodiments of the present disclosure may be appropriately combined.

In addition, unless explicitly stated in the claims, the sequence of processing elements and sequences, the use of numbers and letters, or the use of other names described in the present disclosure are not used to define the sequence of processes and methods in the present disclosure. Although the above disclosure has discussed some currently considered useful embodiments of the invention through various examples, it should be understood that such details are only for the purpose of explanation, and the additional claims are not limited to the disclosed embodiments. On the contrary, the claims are intended to cover all amendments and equivalent combinations that conform to the essence and scope of the embodiments of the present disclosure. For example, although the system components described above can be implemented by hardware devices, they can also be implemented only by software solutions, such as installing the described system on an existing server or mobile device.

Similarly, it should be noted that, in order to simplify the description disclosed in the present disclosure and thus help the understanding of one or more embodiments of the invention, the foregoing description of the embodiments of the present disclosure sometimes incorporates a variety of features into one embodiment, the drawings or the description thereof. However, this disclosure method does not mean that the object of the present disclosure requires more features than those mentioned in the claims. In fact, the features of the embodiments are less than all the features of the single embodiments disclosed above.

Finally, it should be understood that the embodiments described in the present disclosure are only used to illustrate the principles of the embodiments of the present disclosure. Other deformations may also fall within the scope of the present disclosure. Therefore, as an example rather than a limitation, the alternative configuration of the embodiments of the present disclosure can be regarded as consistent with the teachings of the present disclosure. Accordingly, the embodiments of the present disclosure are not limited to those explicitly introduced and described in the present disclosure.

1. A method for controlling a floating window, the method comprising:
acquiring a first operation performed by a user on a terminal device, the first operation being used to instruct the terminal device to execute a first application in a background;
adding a first floating window automatically on a display interface of the terminal device when the first application is executed in the background, the first floating window including a first state and a second state, the first floating window being hidden on the display interface in the first state, the first floating window being displayed on the display interface in the second state;
adding a second floating window associated with the first application after adding the first floating window, the second floating window covering a partial area of the display interface, wherein
when a relative positional relationship of the first floating window and the second floating window satisfies a first preset condition, the first state of the first floating window is switched to the second state; and
wherein the first floating window is configured to close the second floating window.

2. The method of claim 1, wherein the terminal device has an Android operating system, and the Android operating system determines display levels of floating windows on the display interface based on an adding order of the floating windows.

3. The method of claim 1, wherein a shape of the first floating window is a fan shape, and the fan shape is located at a lower right corner of the display interface.

4. The method of claim 1, wherein when the first floating window is in the first state, the first floating window is set to be in a transparent form or a length pixel and a width pixel of the first floating window are set to be smaller than a preset value to make the first floating window hidden in the display interface.

5. The method of claim 1, further comprising:
when the first floating window is switched from the first state to the second state, if the second floating window overlaps the first floating window, switching the first floating window from the second state to a third state to prompt the user to stop operating the second floating window and, that the second floating window will be closed.

6. The method of claim 1, wherein when the first floating window is in the second state, a size of the first floating window is larger than a size of the second floating window.

7-14. (canceled)

15. A computer-readable storage medium, the storage medium storing computer instructions, and after the computer reads the computer instructions in the storage medium, the computer being configured to execute the method according to operations including:
acquiring a first operation performed by a user on a terminal device, the first operation being used to instruct the terminal device to execute a first application in a background;
adding a first floating window automatically on a display interface of the terminal device when the first application is executed in the background, the first floating window including a first state and a second state, the first floating window being hidden on the display interface in the first state, the first floating window being displayed on the display interface in the second state;
adding a second floating window associated with the first application after adding the first floating window, the second floating window covering a partial area of the display interface, wherein
when a relative positional relationship of the first floating window and the second floating window satisfies a first preset condition, the first state of the first floating window is switched to the second state; and
wherein the first floating window is configured to close the second floating window.

16. The computer-readable storage medium of claim 15, wherein the terminal device has an Android operating system, and the Android operating system determines display levels of floating windows on the display interface based on an adding order of the floating windows.

17. The computer-readable storage medium of claim 15, wherein a shape of the first floating window is a fan shape, and the fan shape is located at a lower right corner of the display interface.

18. The computer-readable storage medium of claim 15, wherein when the first floating window is in the first state, the first floating window is set to be in a transparent form or a length pixel and a width pixel of the first floating window are set to be smaller than a preset value to make the first floating window hidden in the display interface.

19. The computer-readable storage medium of claim 15, wherein the operations further include:
when the first floating window is switched from the first state to the second state, if the second floating window overlaps the first floating window, switching the first floating window from the second state to a third state to prompt the user to stop operating the second floating window and that the second floating window will be closed.

20. The system of claim 15, wherein when the first floating window is in the second state, a size of the first floating window is larger than a size of the second floating window.

21. A system, comprising:
at least one storage device, configured to store an instruction set;
at least one processing device, in communication with the at least one storage device, and when the instruction set is executed by the processing device, causing the system to perform following operations, including:
acquiring a first operation performed by a user on a terminal device, the first operation being used to instruct the terminal device to execute a first application in a background;
adding a first floating window automatically on a display interface of the terminal device when the first application is executed in the background, the first floating window including a first state and a second state, the first floating window being hidden on the display interface in the first state, the first floating window being displayed on the display interface in the second state;
adding a second floating window associated with the first application after adding the first floating window, the second floating window covering a partial area of the display interface, wherein
when a relative positional relationship of the first floating window and the second floating window satisfies a first preset condition, the first state of the first floating window is switched to the second state; and
wherein the first floating window is configured to close the second floating window.

22. The system of claim 21, wherein the terminal device has an Android operating system.

23. The system of claim 22, wherein the Android operating system determines display levels of floating windows on the display interface based on an adding order of the floating windows.

24. The system of claim 21, wherein a shape of the first floating window is a fan shape.

25. The system of claim 24, wherein the first floating window in the fan shape is located at a lower right corner of the display interface.

26. The system of claim 21, wherein when the first floating window is in the first state, the first floating window is set to be in a transparent form or a length pixel and a width pixel of the first floating window are set to be smaller than a preset value to make the first floating window hidden in the display interface.

27. The system of claim 21, wherein the operations further include:
when the first floating window is switched from the first state to the second state, if the second floating window overlaps the first floating window, switching the first floating window from the second state to a third state to prompt the user to stop operating the second floating window and, that the second floating window will be closed.

28. The system of claim 21, wherein when the first floating window is in the second state, a size of the first floating window is larger than a size of the second floating window.
